(19) United States
(12) Patent Application Publication
(10) Pub. No.: US 2020/0301484 A1
(43) Pub. Date: Sep. 24, 2020

(54) STORAGE DEVICE FIXING BRACKET

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: YI-SHENG LIN, New Taipei (TW); HUA ZHANG, Wuhan (CN); LING-XIN ZENG, Wuhan (CN)

(21) Appl. No.: 16/558,587

(22) Filed: Sep. 3, 2019

(30) Foreign Application Priority Data
Mar. 19, 2019 (CN) 201910210063.2

(51) Int. Cl. G06F 1/18; F16B 2/06

(52) U.S. Cl. CPC G06F 1/183; F16B 2/06

(57) ABSTRACT

A storage device fixing bracket includes a bracket and a number of fasteners. Each fastener defines at least one groove. The bracket includes a number of guiding portions. When the fasteners are mounted to the bracket, the guiding portions guide the fasteners to a preset position, and the guiding portions extend into the grooves of the fasteners and respectively contact an inner wall of the grooves. The fasteners abut against a storage device mounted in the bracket to bias the storage device within the bracket.

### FIELD

The subject matter herein generally relates to storage device fixing brackets, and more particularly to a storage device fixing bracket capable of more stably mounting a storage device.

### BACKGROUND

Generally, a storage device is installed in a chassis by being mounted in a bracket. The storage device is generally mounted in the bracket by a post or stud fitted with the bracket. However, a gap may exist between the storage device and the post or stud, thereby making the storage device unstably mounted in the bracket.

### BRIEF DESCRIPTION OF THE DRAWINGS

Implementations of the present disclosure will now be described, by way of embodiments, with reference to the attached figures.

FIG. 1 is an assembled, isometric view of an embodiment of a storage device fixing bracket.

FIG. 2 is an exploded, isometric view of the storage device fixing bracket in FIG. 1.

FIG. 3 is similar to FIG. 2, but showing the storage device fixing bracket from another angle.

FIG. 4 is a close-up view of a fastener of the storage device fixing bracket.

FIG. 5 is a cross-sectional view taken along line VI-VI in FIG. 1.

FIG. 6 is similar to FIG. 5, but showing the cross-sectional view from another angle.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

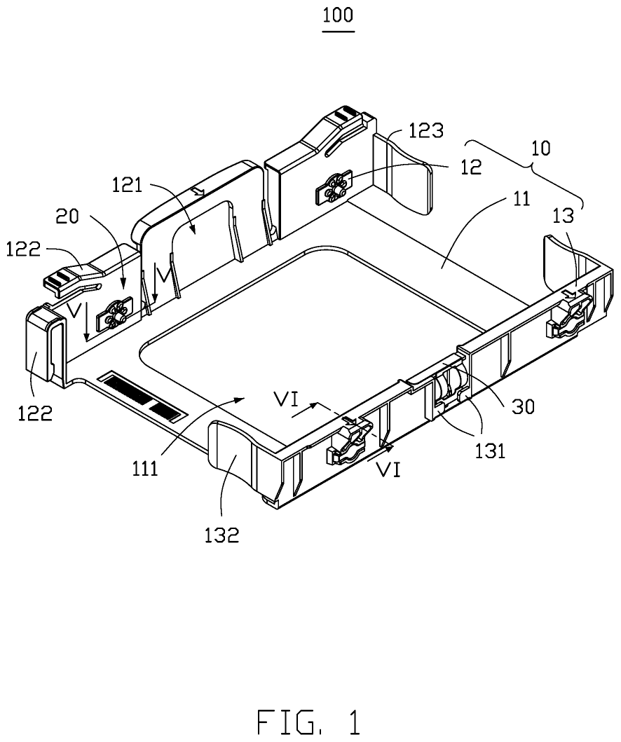

FIGS. 1-3 show an embodiment of a storage device fixing bracket 100 configured to be located in a chassis. The storage device fixing bracket 100 is used for fixing a storage device, such as a hard disk or other type of storage device.

The storage device fixing bracket 100 includes a bracket 10 and a plurality of fasteners 20 for fastening the storage device. The bracket 10 includes a plurality of guiding portions 15. Each fastener 20 defines a groove 23. The fasteners 20 are located corresponding to the guiding portions 15.

When the fastener 20 is mounted on the bracket 10, after the guiding portion 15 guides the fastener 20 to a predetermined position, the guiding portion 15 protrudes into the groove 23 and resists against an inner wall 231 of the groove 23, and the bracket 10 is fixed to the fastener 20 by the guiding portion 15.

As shown in FIG. 1, the bracket 10 further includes a grounding portion 30 configured to contact the chassis for grounding the storage device.

The bracket 10 further includes a base plate 11, a first elastic side panel 12, and a second elastic side panel 13. The first elastic side panel 12 and the second elastic side panel 13 are respectively located on opposite sides of the base plate 11. The first elastic side panel 12 and the second elastic side panel 13 are mounted substantially perpendicularly to the base plate 11 and are elastically deformable relative to the base plate 11.

A first through hole 111 is defined in the base plate 11 for dissipating heat generated by the storage device. In other embodiments, the first through hole 111 may be omitted. The base plate 11 further defines a second through hole 112 adjacent to the second elastic side panel 13. In one embodiment, the second through hole 112 is not in communication with the first through hole 111, and the grounding portion 30 latches through the second through hole 112.

A third through hole 121 is defined in the first elastic side panel 12. The third through hole 121 is not in communication with the first through hole 111. If the storage device mounted in the bracket 10 needs to be removed, the first elastic side panel 12 can be pulled through the third through hole 121 to elastically deform the first elastic side panel 12 so that the storage device can be removed from the bracket 10. An external device may connect with the storage device through the third through hole 121. A clamping portion 122 is located on an end of the first elastic side panel 12 opposite the base plate 11. An end of the first elastic side panel 12 opposite the end where the clamping portion 122 is located includes a latching flap 123. The latching flap 123 is substantially perpendicular to the first elastic side panel 12 and extends toward the second elastic side panel 13. The clamping portion 122 is used for clamping onto the chassis or other components in the chassis, so that the bracket 10 is more stably mounted in the chassis, and the latching flap 123 is used for biasing the storage device within the bracket 10, so that the storage device is more stably mounted in the bracket 10.

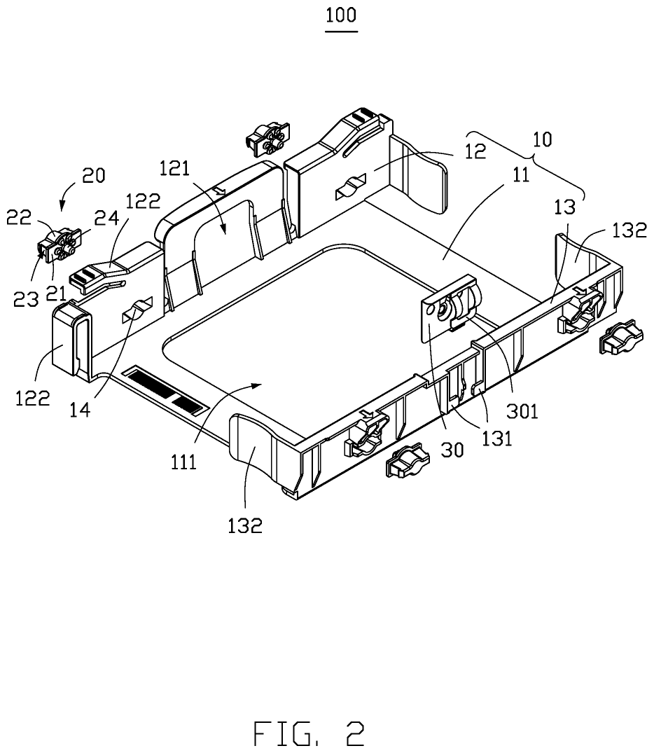

As shown in FIG. 1 and FIG. 2, resisting portions 131 are located on an outer side of the second elastic side panel 13. The resisting portions 131 are configured to resist the grounding portion 30. Each of two ends of the second elastic side panel 13 includes a latching flap 132. The two latching flaps 132 are substantially perpendicular to the second elastic side panel 13 and extend toward the first elastic side panel 12. The two latching flaps 132 on the second elastic side panel 13 cooperate with the latching flap 123 on the first elastic side panel 12 to bias the storage device within the bracket 10. An inner side of the second elastic side panel 13 includes at least one first protrusion 133 for abutting the grounding portion 30.

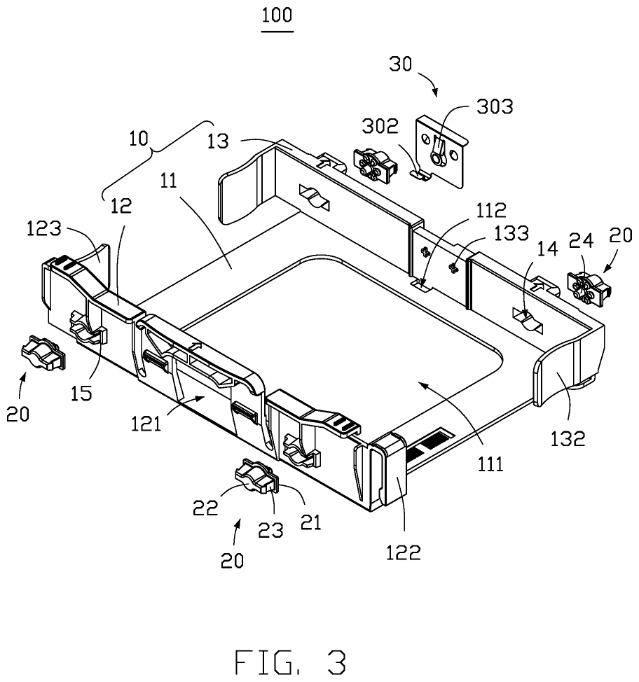

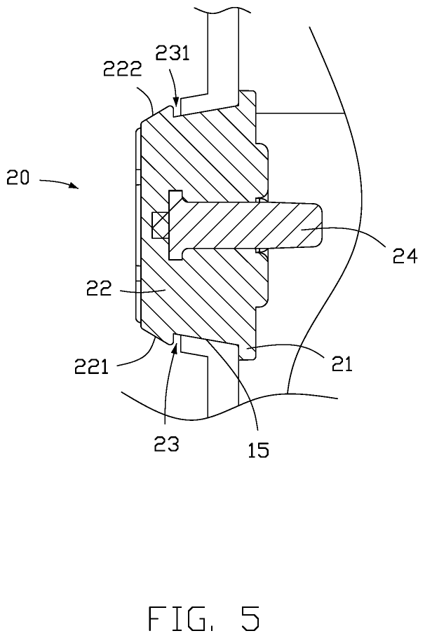

Referring to FIG. 2, FIG. 3, and FIG. 5, an opening 14 is defined in each of the first elastic side panel 12 and the second elastic side panel 13, and each fastener 20 is received in a corresponding opening 14. In one embodiment, the first elastic side panel 12 and the second elastic side panel 13 each define two openings 14. The guiding portion 15 is formed at an edge portion of the opening 14.

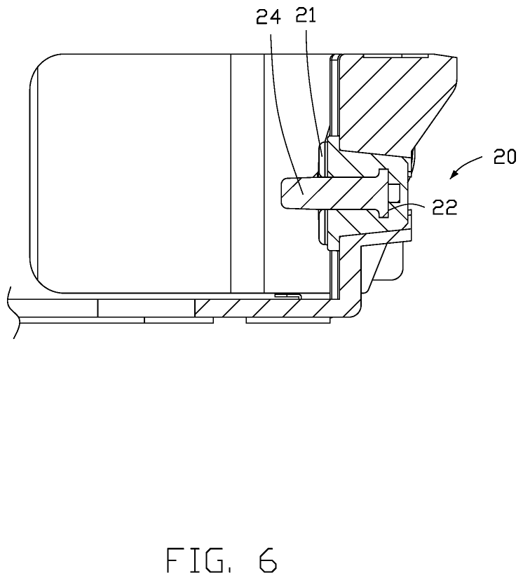

Referring to FIGS. 5 and 6, the guiding portion 15 is located on opposite sides of the opening 14, and the guiding portion 15 is inclined to guide movement of the fastener 20. Specifically, the two guiding portions 15 are respectively inclined toward each other at a same angle. In other embodiments, a quantity of the openings 14 and a position of opening are not limited thereto, and the guiding portions 15 may be located on other sides of the opening 14. In one embodiment, the guiding portions 15 extend toward outside of the first elastic side panel 12 and the second elastic side panel 13. When the fastener 20 is mounted on the bracket 10, the guiding portions 15 abut against the fastener 20.

A quantity of the fasteners 20 is equal to the quantity of the openings 14. The fastener 20 includes a first fixing portion 21 and a second fixing portion 22. The first fixing portion 21 and the second fixing portion 22 abut against the bracket 10, and the second fixing portion 22 is guided by the guiding portions 15.

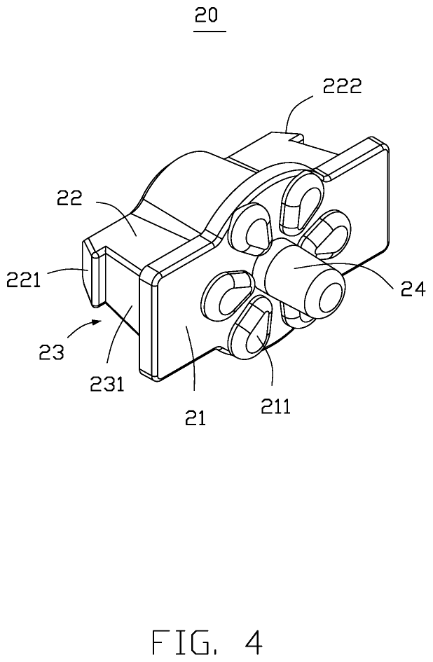

As shown in FIG. 4, a side of the first fixing portion 21 facing away from the second fixing portion 22 includes at least one second protrusion 211 for abutting the storage device in the bracket 10, so that the storage device is mounted more stably in the bracket 10. The second fixing portion 22 includes a first inclined surface 221 and a second inclined surface 222. The first inclined surface 221 and the second inclined surface 222 are respectively located on opposite sides of the second fixing portion 22. A direction of inclination of the first slanted surface 221 and of the second slanted surface 222 is the same as a direction of inclination of the two guiding portions 15. Opposite surfaces of the second fixing portion 22 are formed by a central circular arc surface and two lateral planar surfaces, but are not limited thereto.

Referring to FIG. 4, FIG. 5, and FIG. 6, the groove 23 is defined on opposite sides of the fastener 20, and the first inclined surface 221 and the second inclined surface 222 are each adjacent to the corresponding groove 23. Boundaries of the groove 23 are defined by the first fixing portion 21 and the second fixing portion 22. The inner wall 231 of the groove 23 is slanted, and a direction and angle of slant of the inner wall 231 are the same as the direction and angle of slant of the two guiding portions 15. When the fastener 20 is mounted to the bracket 10, the guiding portions 15 are in contact with the inner wall 231.

Referring to FIG. 4, the fastener 20 further includes a protruding post 24. The protruding post 24 protrudes from a surface of the first fixing portion 21 and is used to clamp the storage device.

When the fastener 20 is mounted on the bracket 10, an end of the second fixing portion 22 away from the first fixing portion 21 first passes through the opening 14, and then the guiding portions 15 guide the first fixing portion 21 by engagement of the first inclined surface 221 and the second inclined surface 222 with the guiding portions 15. After the second fixing portion 22 is moved to a predetermined position, the guiding portions 15 protrude into the grooves 23 to engage with the inner walls 231, and the first fixing portion 21 abuts against inner surfaces of the first elastic side panel 12 or the second elastic side panel 13, thereby fastening the fasteners 20 on the first elastic side panel 12 and the second elastic side panel 13.

Referring to FIG. 2 and FIG. 3, the grounding portion 30 is configured to further connect the storage device to the chassis casing. Specifically, the grounding portion 30 includes a first abutting portion 301, a second abutting portion 302, and a third abutting portion 303. When the grounding portion 30 is mounted to the bracket 10, the first abutting portion 301 is configured to abut against the resisting portion 131, the second abutting portion 302 is configured to abut against an edge of the second through hole 112, and the third abutting portion 303 is configured to abut against the storage device to connect the storage device to the chassis to achieve a grounding effect. In other embodiments, the grounding portion 30 may be mounted to other portions of the bracket 10 and be structurally different, as long as the grounding portion 30 connects the storage device to the chassis.

In summary, the storage device fixing bracket 100 can more stably mount the storage device in the bracket 10 by using the fasteners 20 and the grounding portion 30. The fasteners 20 are mounted to the bracket 10 along a direction parallel to the base plate 11, and the grounding portion 30 is mounted to the bracket 10 along a direction perpendicular to the base plate 11. The fasteners 20 are more stably clamped on the bracket 10 by engagement of the first inclined surface 221 and the second inclined surface 222 with the guiding portions 15, and the guiding portions 15 extending outside of the bracket 10 enhances guiding of the fasteners 20 to be mounted on the bracket 10.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A storage device fixing bracket comprising:
a bracket; and
a plurality of fasteners; wherein:
each of the plurality of fasteners defines at least one groove;
the bracket comprises a plurality of guiding portions;
when the plurality of fasteners are mounted to the bracket, the plurality of guiding portions guide the plurality of fasteners to a preset position, and the plurality of guiding portions extend into the grooves of the plurality of fasteners and respectively contact an inner wall of the grooves; and
the plurality of fasteners abut against a storage device mounted in the bracket to bias the storage device within the bracket.

2. The storage device fixing bracket of claim 1, wherein:
the guiding portions and the inner wall of the grooves have a same inclination angle.

3. The storage device fixing bracket of claim 2, wherein:
each of the plurality of fasteners comprises a first fixing portion and a second fixing portion;
the first fixing portion and the second fixing portion abut against the bracket; and
the second fixing portion is guided by the guiding portions.

4. The storage device fixing bracket of claim 3, wherein:
the second fixing portion comprises a first slanted surface and a second slanted surface; and
the first slanted surface and the second slanted surface are located on opposite sides of the second fixing portion.

5. The storage device fixing bracket of claim 4, wherein:
the second fixing portion defines two grooves; and
a bottom of the two grooves respectively form the first slanted surface and the second slanted surface.

6. The storage device fixing bracket of claim 1, wherein:
the fastener comprises a protruding post configured to abut the storage device; and
the protruding post protrudes from a surface of the first fixing portion.

7. The storage device fixing bracket of claim 1, wherein:
the bracket comprises a base plate and two elastic side panels; and
the two elastic side panels are respectively located on opposite sides of the base plate.

8. The storage device fixing bracket of claim 7, wherein:
at least one opening is defined in each elastic side panel; and
each fastener is received in a corresponding opening.

9. The storage device fixing bracket of claim 1, further comprising a grounding portion configured to latch with the bracket, wherein:
the grounding portion comprises an abutting portion configured to abut against the bracket;
the ground portion comprises another abutting portion configured to connect the storage device to an external component to ground the storage device.

10. A storage device fixing bracket comprising:
a bracket;
a plurality of fasteners; and
a grounding portion configured to connect a storage device mounted in the bracket to an external component; wherein:
each of the plurality of fasteners defines at least one groove;
the bracket comprises a plurality of guiding portions;
when the plurality of fasteners are mounted to the bracket, the plurality of guiding portions guide the plurality of fasteners to a preset position, and the plurality of guiding portions extend into the grooves of the plurality of fasteners and respectively contact an inner wall of the grooves;
the plurality of fasteners abut against a storage device mounted in the bracket to bias the storage device within the bracket.

11. The storage device fixing bracket of claim 10, wherein:
the bracket comprises a base plate, a first elastic side panel, and a second elastic side panel;
the first elastic side panel and the second elastic side panel are respectively located on opposite sides of the base plate;
the fasteners are mounted to the bracket along a direction parallel to the base plate; and
the grounding portion is mounted to the bracket along a direction perpendicular to the base plate.

12. The storage device fixing bracket of claim 11, wherein:
the guiding portions and the inner wall of the grooves have a same inclination angle.

13. The storage device fixing bracket of claim 12, wherein:
each of the plurality of fasteners comprises a first fixing portion and a second fixing portion;
the first fixing portion and the second fixing portion abut against the bracket; and
the second fixing portion is guided by the guiding portions.

14. The storage device fixing bracket of claim 13, wherein:
the second fixing portion comprises a first slanted surface and a second slanted surface; and
the first slanted surface and the second slanted surface are located on opposite sides of the second fixing portion.

15. The storage device fixing bracket of claim 14, wherein:
the second fixing portion defines two grooves; and
a bottom of the two grooves respectively form the first slanted surface and the second slanted surface.

16. The storage device fixing bracket of claim 11, wherein:
the fastener comprises a protruding post configured to abut the storage device; and
the protruding post protrudes from a surface of the first fixing portion.
